(19) United States
(12) Patent Application Publication
(10) Pub. No.: US 2025/0211406 A1
(43) Pub. Date: Jun. 26, 2025

(54) METHODS AND APPARATUSES FOR SLOT FORMAT CONFIGURATION

(71) Applicant: Lenovo (Beijing) Limited, Beijing (CN)

(72) Inventors: Yu Zhang, Beijing (CN); Haipeng Lei, Beijing (CN)

(73) Assignee: Lenovo (Beijing) Limited, Beijing (CN)

(21) Appl. No.: 18/850,314

(22) PCT Filed: Mar. 24, 2022
(86) PCT No.: PCT/CN2022/082785

§ 371 Date: Sep. 24, 2024

(51) Int. Cl. H04L 5/00; H04L 1/1607; H04W 72/0446

(52) U.S. Cl. CPC H04L 5/0098; H04L 1/1614; H04L 5/0005; H04W 72/0446

(57) ABSTRACT

The present application relates to methods and apparatuses for slot format configuration. One embodiment of the present disclosure provides a user equipment (UE) which includes a transceiver and a processor coupled with the transceiver. The processor is configured to: receive, with the transceiver, one or more downlink control information (DCI) messages, wherein the one or more DCI messages indicate a communication format configuration corresponding to a set of slots and a set of sub-bands within a carrier; and determine a slot format for each slot of the set of slots and for each sub-band of the set of sub-bands based on the one or more DCI messages.

### TECHNICAL FIELD

The present disclosure generally relates to communication technologies, and especially to methods and apparatuses for slot format configuration.

### BACKGROUND OF THE INVENTION

Time Division Duplexing (TDD) is widely used in wireless networks. When operating TDD in a wireless network, only one transmission direction, that is, downlink (DL) or uplink (UL) is supported in a given time duration. However, allocation of a limited time duration for the UL transmissions would result in reduced coverage and increased latency. Therefore, it would be worth allowing the simultaneous existence of DL transmissions and UL transmissions in a given time duration, a.k.a. full duplex. More specifically, sub-band non-overlapping full duplex mode can be implemented in a wireless network, that is, the network can support simultaneous UL transmissions and DL transmissions occupying the non-overlapping sub-bands.

For operating sub-band non-overlapping full duplex mode in a wireless network, it is important to indicate the transmission direction for multiple sub-bands to the devices in the wireless network such that the devices can perform the corresponding procedures, for example, transmit UL transmissions or receive DL transmissions.

### SUMMARY

An embodiment of the present disclosure provides a UE which includes a transceiver and a processor coupled with the transceiver. The processor is configured to: receive, with the transceiver, one or more downlink control information (DCI) messages, wherein the one or more DCI messages indicate a communication format configuration corresponding to a set of slots and a set of sub-bands within a carrier; and determine a slot format for each slot of the set of slots and for each sub-band of the set of sub-bands based on the one or more DCI messages.

In some embodiments, the one or more DCI messages include at least one slot format indicator (SFI) indicating a slot format for each slot of the set of slots.

In some embodiments, the one or more DCI messages further include a sub-band pattern indicator (SPI) including a set of bitmaps, wherein each bitmap of the set of bitmaps is associated with a symbol in the set of slots and indicates a transmission direction for each sub-band of the set of sub-bands.

In some embodiments, a bitmap of the set of bitmaps is valid in determining the slot format for each slot of the set of slots and for each sub-band of the set of sub-bands when it is associated with a flexible symbol indicated by the slot format indicated by the SFI.

In some embodiments, a number of bitmaps included in the set of bitmaps is determined based on one of: a maximum number of slot formats included in a slot format combination, a monitoring periodicity for the one or more DCI messages, or a maximum number of flexible symbols in a slot format combination.

In some embodiments, the one or more DCI messages further include a set of SPIs, wherein each SPI in the set of SPIs indicates: a starting resource block (RB) and a number of contiguous RBs of an associated time-frequency domain resource; a starting symbol and a number of consecutive symbols of the associated time-frequency domain resource; and a transmission direction.

In some embodiments, the one or more DCI messages include one or more pairs of SFIs and SPIs, each SPI corresponds to an SFI and indicates an index of a sub-band associated with the corresponding SFI, and each SFI indicates a slot format for each slot of the set of slots and for an associated sub-band of the set of sub-bands.

In some embodiments, the one or more DCI messages include one or more SFIs and one SPI, each SFI indicates a slot format for each slot of the set of slots and for an associated sub-band of the set of sub-bands, and the SPI includes a bitmap indicating the sub-band(s) associated with the one or more SFIs.

In some embodiments, the one or more DCI messages include a set of SFIs, and each SFI indicates a slot format for each slot of the set of slots and for an associated sub-band of the set of sub-bands.

In some embodiments, the processor is further configured to: receive, with the transceiver, at least one configuration for an uplink transmission corresponding to one or more sub-bands of the set of sub-bands and a number of symbols in the set of slots; and perform, with the transceiver, the uplink transmission if all the determined slot formats corresponding to the one or more sub-bands indicate that the number of symbols are uplink symbols.

In some embodiments, the processor is further configured to: receive, with the transceiver, at least one configuration for a downlink transmission corresponding to one or more sub-bands of the set of sub-bands and a number of symbols in the set of slots; and receive, with the transceiver, the downlink transmission if all the determined slot formats corresponding to the one or more sub-bands indicate that the number of symbols are downlink symbols.

Another embodiment of the present disclosure provides a BS which includes a transceiver and a processor coupled with the transceiver. The processor is configured to: determine one or more DCI messages, wherein the one or more DCI messages indicate a communication format configuration corresponding to a set of slots and a set of sub-bands within a carrier; and transmit the one or more DCI messages.

In some embodiments, the one or more DCI messages include at least one SFI indicating a slot format for each slot of the set of slots.

In some embodiments, the one or more DCI messages further include an SPI including a set of bitmaps, wherein each bitmap of the set of bitmaps is associated with a symbol in the set of slots and indicates a transmission direction for each sub-band of the set of sub-bands.

In some embodiments, a bitmap of the set of bitmaps is valid when it is associated with a flexible symbol indicated by the slot format indicated by the SFI.

In some embodiments, a number of bitmaps included in the set of bitmaps is determined based on one of: a maximum number of slot formats included in a slot format combination, a monitoring periodicity for the one or more DCI messages, or a maximum number of flexible symbols in a slot format combination.

In some embodiments, the one or more DCI messages further include a set of SPIs, wherein each SPI in the set of SPIs indicates: a starting RB and a number of contiguous RBs of an associated time-frequency domain resource; a starting symbol and a number of consecutive symbols of the associated time-frequency domain resource; and a transmission direction.

In some embodiments, the one or more DCI messages include one or more pairs of SFIs and SPIs, each SPI corresponds to an SFI and indicates an index of a sub-band associated with the corresponding SFI, and each SFI indicates a slot format for each slot of the set of slots and for an associated sub-band of the set of sub-bands.

In some embodiments, the one or more DCI messages include one or more SFIs and one SPI, each SFI indicates a slot format for each slot of the set of slots and for an associated sub-band of the set of sub-bands, and the SPI includes a bitmap indicating the sub-band(s) associated with the one or more SFIs.

In some embodiments, the one or more DCI messages include a set of SFIs, and each SFI indicates a slot format for each slot of the set of slots and for an associated sub-band of the set of sub-bands.

Yet another embodiment of the present disclosure provides a method performed by a UE. The method includes: receiving one or more DCI messages, wherein the one or more DCI messages indicate a communication format configuration corresponding to a set of slots and a set of sub-bands within a carrier; and determining a slot format for each slot of the set of slots and for each sub-band of the set of sub-bands based on the one or more DCI messages.

In some embodiments, the one or more DCI messages include at least one SFI indicating a slot format for each slot of the set of slots.

In some embodiments, the one or more DCI messages further include an SPI including a set of bitmaps, wherein each bitmap of the set of bitmaps is associated with a symbol in the set of slots and indicates a transmission direction for each sub-band of the set of sub-bands.

In some embodiments, a bitmap of the set of bitmaps is valid in determining the slot format for each slot of the set of slots and for each sub-band of the set of sub-bands when it is associated with a flexible symbol indicated by the slot format indicated by the SFI.

In some embodiments, a number of bitmaps included in the set of bitmaps is determined based on one of: a maximum number of slot formats included in a slot format combination, a monitoring periodicity for the one or more DCI messages, or a maximum number of flexible symbols in a slot format combination.

In some embodiments, the one or more DCI messages further include a set of SPIs, wherein each SPI in the set of SPIs indicates: a starting RB and a number of contiguous RBs of an associated time-frequency domain resource; a starting symbol and a number of consecutive symbols of the associated time-frequency domain resource; and a transmission direction.

In some embodiments, the one or more DCI messages include one or more pairs of SFIs and SPIs, each SPI corresponds to an SFI and indicates an index of a sub-band associated with the corresponding SFI, and each SFI indicates a slot format for each slot of the set of slots and for an associated sub-band of the set of sub-bands.

In some embodiments, the one or more DCI messages include one or more SFIs and one SPI, each SFI indicates a slot format for each slot of the set of slots and for an associated sub-band of the set of sub-bands, and the SPI includes a bitmap indicating the sub-band(s) associated with the one or more SFIs.

In some embodiments, the one or more DCI messages include a set of SFIs, and each SFI indicates a slot format for each slot of the set of slots and for an associated sub-band of the set of sub-bands.

In some embodiments, the method further comprises: receiving at least one configuration for an uplink transmission corresponding to one or more sub-bands of the set of sub-bands and a number of symbols in the set of slots; and performing the uplink transmission if all the determined slot formats corresponding to the one or more sub-bands indicate that the number of symbols are uplink symbols.

In some embodiments, the method further comprises: receiving at least one configuration for a downlink transmission corresponding to one or more sub-bands of the set of sub-bands and a number of symbols in the set of slots; and receiving the downlink transmission if all the determined slot formats corresponding to the one or more sub-bands indicate that the number of symbols are downlink symbols.

Still another embodiment of the present disclosure provides a method performed by a BS. The method includes: determining one or more DCI messages, wherein the one or more DCI messages indicate a communication format configuration corresponding to a set of slots and a set of sub-bands within a carrier; and transmitting the one or more DCI messages.

In some embodiments, the one or more DCI messages include at least one SFI indicating a slot format for each slot of the set of slots.

In some embodiments, the one or more DCI messages further include an SPI including a set of bitmaps, wherein each bitmap of the set of bitmaps is associated with a symbol in the set of slots and indicates a transmission direction for each sub-band of the set of sub-bands.

In some embodiments, a bitmap of the set of bitmaps is valid when it is associated with a flexible symbol indicated by the slot format indicated by the SFI.

In some embodiments, a number of bitmaps included in the set of bitmaps is determined based on one of: a maximum number of slot formats included in a slot format combination, a monitoring periodicity for the one or more DCI messages, or a maximum number of flexible symbols in a slot format combination.

In some embodiments, the one or more DCI messages further include a set of SPIs, wherein each SPI in the set of SPIs indicates: a starting RB and a number of contiguous RBs of an associated time-frequency domain resource; a starting symbol and a number of consecutive symbols of the associated time-frequency domain resource; and a transmission direction.

In some embodiments, the one or more DCI messages include one or more pairs of SFIs and SPIs, each SPI corresponds to an SFI and indicates an index of a sub-band associated with the corresponding SFI, and each SFI indicates a slot format for each slot of the set of slots and for an associated sub-band of the set of sub-bands.

In some embodiments, the one or more DCI messages include one or more SFIs and one SPI, each SFI indicates a slot format for each slot of the set of slots and for an associated sub-band of the set of sub-bands, and the SPI includes a bitmap indicating the sub-band(s) associated with the one or more SFIs.

In some embodiments, the one or more DCI messages include a set of SFIs, and each SFI indicates a slot format for each slot of the set of slots and for an associated sub-band of the set of sub-bands.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary wireless communications system in accordance with some embodiments of the present disclosure.

FIG. 2 illustrates an exemplary allocation of sets of REs corresponding to simultaneous UL and DL transmissions when operating a sub-band non-overlapping full duplex mode.

FIG. 3 illustrates an exemplary slot format for a slot according to some embodiments of the present disclosure.

FIGS. 4A and 4B illustrate exemplary sub-bands configurations according to some embodiments of the present disclosure.

FIG. 5A illustrates exemplary determined sub-band-specific slot formats corresponding to a slot of a set of slots and a set of sub-bands according to some embodiments of the present disclosure.

FIG. 5B illustrates an exemplary communication format configuration corresponding to a set of slots and a set of sub-bands within a carrier according to some embodiments of the present disclosure.

FIG. 5C illustrates another exemplary communication format configuration corresponding to a set of slots and a set of sub-bands within a carrier according to some embodiments of the present disclosure.

FIG. 5D illustrates another exemplary communication format configuration corresponding to a set of slots and a set of sub-bands within a carrier according to some embodiments of the present disclosure.

FIG. 6 illustrates a flow chart of an exemplary procedure of wireless communications in accordance with some embodiments of the present disclosure.

FIG. 7 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that among all illustrated operations, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3rd generation partnership project (3GPP) long-term evolution (LTE) and LTE Advanced, 3GPP 5G new radio (NR), 5G-Advanced, 6G and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

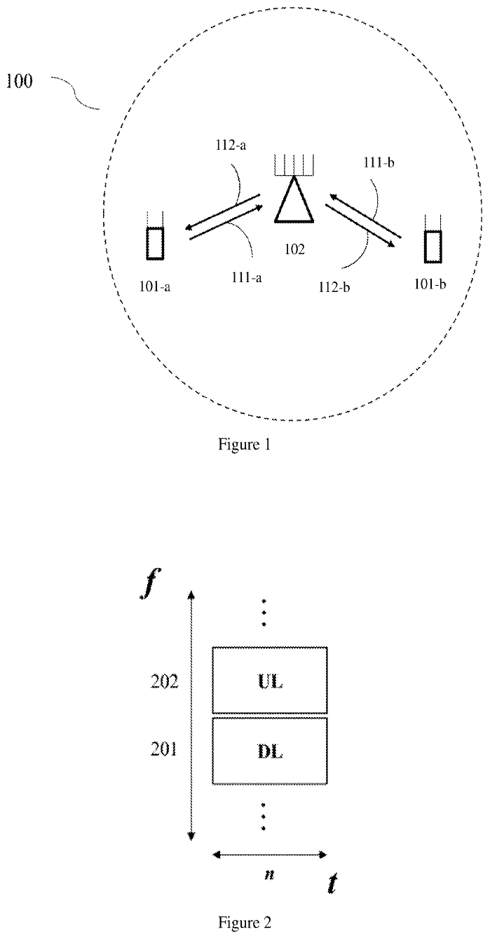

FIG. 1 illustrates an exemplary wireless communications system 100 in accordance with some embodiments of the present disclosure.

Referring to FIG. 1, the wireless communications system 100 may include one or more UEs (e.g., UE 101-a and UE 101-b, collectively referred to as UEs 101), and at least a BS 102. Although a specific number of UEs 101 and BS 102 are depicted in FIG. 1, it is contemplated that any number of UEs and BSs may be included in the wireless communications system 100.

In some embodiments of the present disclosure, the UEs 101 may be devices in different forms or having different capabilities. According to some embodiments of the present disclosure, the UEs 101 may include or may be referred to as computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UEs 101 may include or may be referred to as portable wireless communication devices, such as smart phones, cellular telephones, flip phones, or any other device that is capable of transmitting and receiving information. In some embodiments, the UEs 101 may include or may be referred to as wearable devices, such as smart watches, fitness bands, optical head-mounted displays, or the like. Moreover, the UEs 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present disclosure, the BS 102 may be referred to as an access point, an access terminal, a base, a base unit, a macro cell, a Node B, an enhanced Node B, an evolved Node B, a next generation Node B (gNB), a Home Node B, a relay node, or a device, or described using other terminology used in the art. The BS 102 is generally a part of a radio access network that may include one or more controllers communicably coupled to one or more corresponding BS 102.

The wireless communications system 100 may be compatible with any type of network that is capable of exchanging information between the BS 102 and the UEs 101. For example, the wireless communications system 100 may be a cellular telephone network, a time division multiple access (TDMA)-based network, a code division multiple access (CDMA)-based network, an orthogonal frequency division multiple access (OFDMA)-based network, a 3GPP-based network, a 3GPP LTE network, a 3GPP 5G NR network, a satellite communications network, a high-altitude platform network, or one of other communications networks. More generally, however, the wireless communications system 100 may implement some other open or proprietary communication protocols, for example, IEEE 802.11 family, WiMAX, among other protocols.

In some embodiments of the present disclosure, the BS 102 may be dispersed throughout a geographic area to form the wireless communications system 100 and may be a device in different forms or having different capabilities. The information exchanges between the BS 102 and the UEs 101 in the wireless communications system 100 may include uplink (UL) transmissions (e.g., UL transmission 111-a and UL transmission 111-b, collectively referred to UL transmissions 111) from the UEs 101 to the BS 102, or downlink (DL) transmissions 112 from the BS 102 to the UEs 101 (e.g., DL transmission 112-a and DL transmission 112-b, collectively referred to DL transmissions 112) over one or more carriers. A carrier may be a portion of a radio frequency spectrum band and may be associated with a particular bandwidth (e.g., 20 megahertz (MHz)). A carrier may be made up of multiple subcarriers and a resource block (RB) is defined as 12 consecutive subcarriers. In some examples, there may be multiple sub-bands within a carrier and each sub-band may include a number of consecutive RBs. The time intervals for the wireless communications system 100 may be expressed in multiples of a basic time unit and may be organized according to radio frames each having a specified duration (e.g., 10 milliseconds (ms)). In some examples, a radio frame may be divided into subframes, and each subframe may be further divided into a number of slots. Alternatively, each radio frame may include a variable number of slots and each slot includes a number of symbols (e.g., 14 symbols). The UL and DL transmissions may include physical channel transmissions and physical signal transmissions. A physical channel transmission or a physical signal transmission is transmitted on a set of time-frequency domain resources having a defined physical layer structure. Each time-frequency domain resource may be referred to as a resource element (RE) which may consist of one symbol in time domain and one subcarrier in frequency domain. A set of REs corresponding to a physical channel transmission or a physical signal transmission may span a number of symbols in time domain and a number of subcarriers within one or more sub-bands in frequency domain, that is, the physical channel transmission or the physical signal transmission may be transmitted in a number of symbols and within one or more sub-bands.

In some embodiments of the present disclosure, for the wireless communications system 100, a sub-band non-overlapping full duplex mode may be supported for enhanced coverage, reduced latency, improved system capacity, and improved configuration flexibility, that is, there may be simultaneous UL transmission(s) 111-a from the UE 101-a to the BS 102 and DL transmission(s) 112-b from the BS 102 to the UE 101-b, and the UL transmission(s) 111-a and the DL transmission(s) 112-b are transmitted within non-overlapping sub-bands.

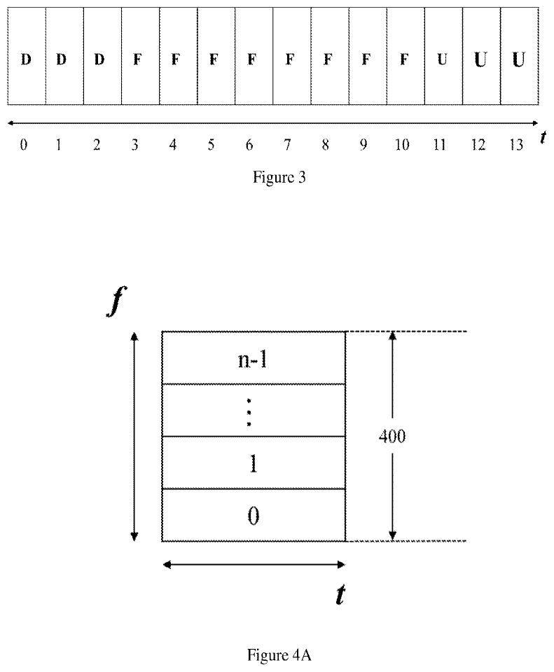

FIG. 2 illustrates an exemplary allocation of sets of REs corresponding to simultaneous UL and DL transmissions when operating a sub-band non-overlapping full duplex mode. In the example of FIG. 2, slot #n is shown in time domain (i.e., the horizontal axis marked by “t”), and non-overlapping sub-band 201 and sub-band 202 are shown in frequency domain (i.e., the vertical axis marked by “f”). A DL transmission (e.g., DL transmission 112-b) may be transmitted in the slot #n within the sub-band 201, and a UL transmission (e.g., UL transmission 111-a) may be transmitted in the slot #n within the sub-band 202.

In some embodiments of the present disclosure, in the wireless communications system 100, for a carrier, a UE can be provided with one or more slot formats after receiving a first DCI message and a higher layer signaling. The first DCI message may be a group common (GC) DCI message and may be carried by a GC-PDCCH. A slot format can indicate a transmission direction for each symbol in a slot, and the transmission direction can be downlink, uplink or flexible. For example, a slot format “DDDFFFFFFFFUUU” for a slot including 14 symbols (e.g., symbol #0 to symbol #13) is shown in FIG. 3, wherein “D” denotes a downlink symbol, “U” denotes an uplink symbol, and “F” denotes a flexible symbol.

More specifically, for the carrier, the UE may be configured by the higher layer signaling with a location of a slot format indicator (SFI)-index field (also referred to as SFI) in the first DCI message. The UE may also be configured by the higher layer signaling with a set of slot format combinations. Each slot format combination in the set of slot format combinations may include:
1. one or more slot formats; and
2. a mapping for the slot format combination to a value of the corresponding SFI-index field in the first DCI message.

After receiving the first DCI message in a first slot, the UE may find a value of the SFI-index field according to the configured location of the SFI-index field in the first DCI message, and may further determine the configured one or more slot formats included in the slot format combination corresponding to the value of the SFI for one or more consecutive slots starting from the first slot. The number of the one or more consecutive slots equals the number of the one or more slot formats corresponding to the value of the SFI. In other words, the SFI in the first DCI message indicates to the UE a slot format for each slot of a number of consecutive slots starting from the first slot, and the number of the consecutive slots equals to the number of the one or more slot formats corresponding to the value of the SFI. For example, in the case that the UE detects the first DCI message at slot #n, and the value of the SFI in the first DCI message corresponds to a slot format combination including three slot formats, the UE may determine three slot formats for slot #n, slot #n+1, and slot #n+2.

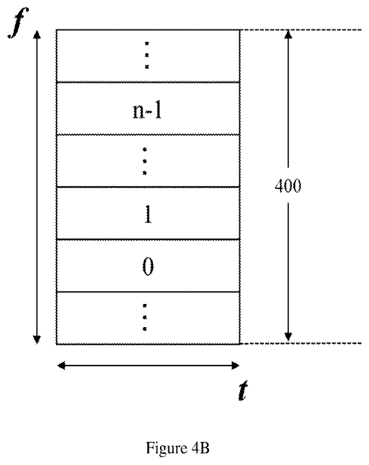

In some embodiments of the present disclosure, for the wireless communications system 100, a UE can determine that there are one or more sub-bands within a carrier. FIGS. 4A and 4B illustrate exemplary sub-bands configurations according to some embodiments of the present disclosure.

In FIGS. 4A and 4B, a carrier 400 is shown in the frequency domain. A UE may determine n sub-bands (e.g., sub-bands #0, #1, . . . , #n−1) within the carrier 400, where n is a positive integer. The total bandwidth of the n sub-bands may be equal to or less than the bandwidth of the carrier 400. In the example of FIG. 4A, the UE determines that the whole carrier 400 splits into n sub-bands, i.e., the total bandwidth of the n sub-bands is equal to the bandwidth of the carrier 400. In the example of FIG. 4B, the UE determines that a part of the carrier 400 splits into n sub-bands, i.e., the total bandwidth of the n sub-bands is less than the bandwidth of the carrier 400.

In some embodiments of the present disclosure, for the wireless communications system 100, in some examples, the UE 101 may be indicated to transmit at least one UL transmission (e.g., a physical uplink shared channel (PUSCH) transmission) on a set of REs after receiving a second DCI message from the BS 102. In some other examples, the UE 101 may be indicated to transmit at least one UL transmission (e.g., a physical uplink control channel (PUCCH) transmission) on a set of REs after receiving a higher layer signaling and a third DCI message from the BS 102. In some other examples, the UE 101 may be indicated to transmit at least one UL transmission (e.g., a PUCCH transmission) on a set of REs after receiving a higher layer signaling from the BS 102.

In some other embodiments of the present disclosure, for the wireless communications system 100, in some examples, the UE 101 may be indicated to receive at least one DL transmission (e.g., a physical downlink shared channel (PDSCH) transmission) on a set of REs after receiving a third DCI message from the BS 102. In some other examples, the UE 101 may be indicated to receive at least one DL transmission (e.g., a physical downlink reference signal transmission) on a set of REs after receiving a higher layer signaling and a third DCI message from the BS 102. In some other examples, the UE 101 may be indicated to receive at least one DL transmission (e.g., a physical downlink reference signal transmission) on a set of REs after receiving a higher layer signaling from the BS 102. In the context of the present disclosure, for a UE, transmitting a UL transmission may also be referred to as performing a UL transmission or the like, and receiving a DL transmission may also be referred to as performing a DL reception or the like; for a BS, transmitting a DL transmission may also be referred to as performing a DL transmission or the like, and receiving a UL transmission may also be referred to as performing a UL reception or the like.

The present disclosure provides various solutions for supporting sub-band non-overlapping full duplex mode for enhanced coverage, reduced latency, improved system capacity, and improved configuration flexibility. For operating sub-band non-overlapping full duplex mode, it is important to indicate a communication format configuration not only corresponding to a set of slots but also corresponding to a set of sub-bands within a carrier.

Based on the communication format configuration, which is indicated by a first DCI message, a UE can determine a slot format for each slot of the set of slots and for each sub-band of the set of sub-bands, that is, the UE can determine one or more sub-band-specific slot formats, and each sub-band-specific slot format corresponds to a slot of the set of slots and a sub-band of the set of sub-bands.

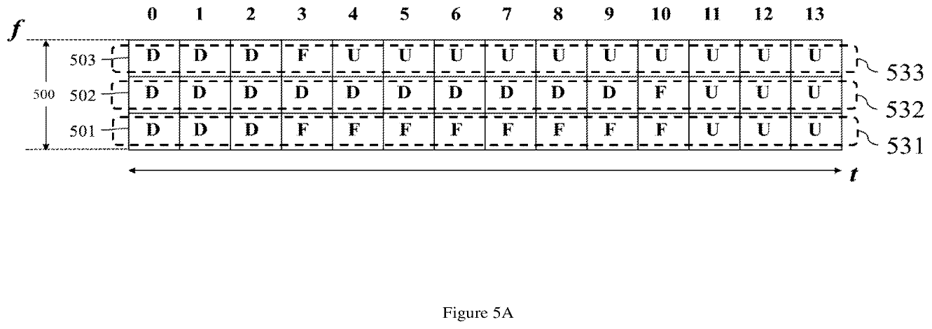

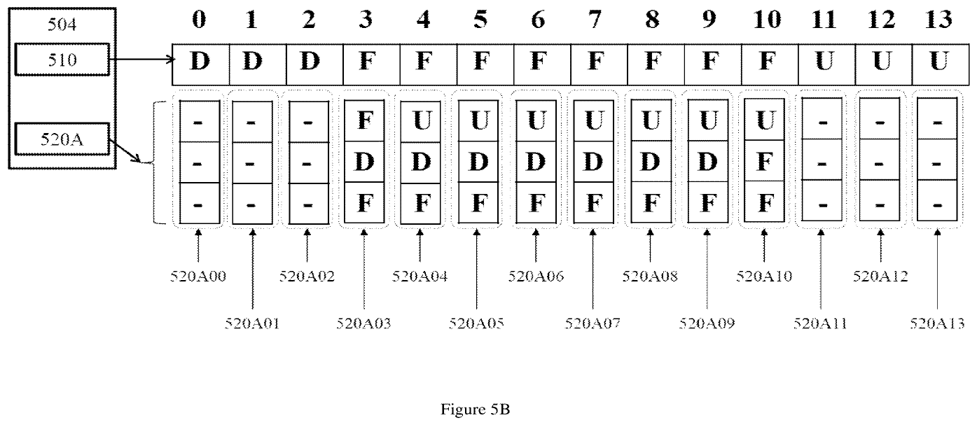

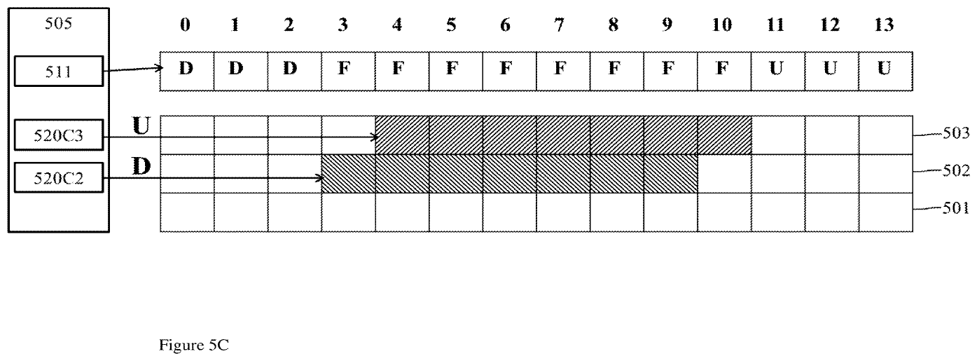

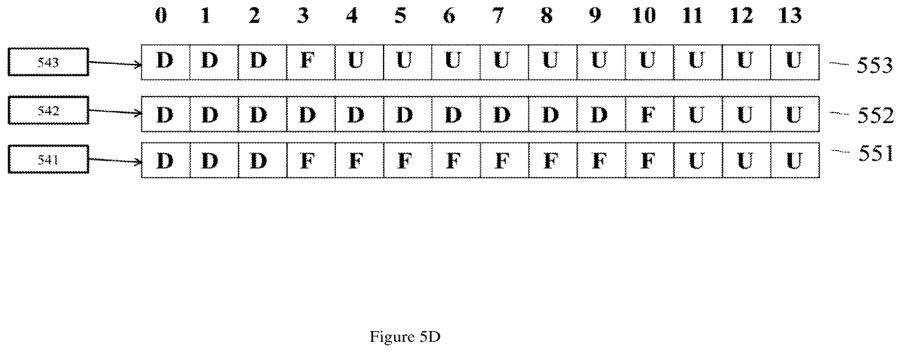

FIG. 5A illustrates exemplary determined sub-band-specific slot formats corresponding to a slot of a set of slots and a set of sub-bands according to some embodiments of the present disclosure.

FIG. 5B illustrates an exemplary communication format configuration corresponding to a set of slots and a set of sub-bands within a carrier according to some embodiments of the present disclosure.

In the example shown in FIGS. 5A and 5B, for a carrier 500, a UE (e.g., UE 101 in FIG. 1) can be provided with one or more slot formats after receiving an SFI in a first DCI message and a higher layer signaling. The SFI indicates a slot format for each slot of a set of slots. The number of the slots included in the set of slots equals the number of the one or more slot formats. The UE can determine that there are a set of sub-bands within the carrier 500. The UE may be further configured by the higher layer signaling with a location of an SPI in the first DCI message. Based on the configured location of the SPI, the UE may find a value of the SPI in the first DCI message. The SPI may be used for indicating a sub-band pattern at least for each symbol of a set of symbols which are indicated to be flexible symbols by the SFI. A sub-band pattern indicates a transmission direction (e.g., downlink, uplink or flexible) for each sub-band of the set of sub-bands. The SPI may be referred to as other names, and the present disclosure has no intention of limiting the same.

The SPI may include a set of bitmaps, and each bitmap may be associated with a symbol in the set of slots. In some embodiments, each bitmap may have a one-to-one mapping with the set of sub-bands and indicate a transmission direction for each sub-band of the set of sub-bands. For example, as shown in FIGS. 5A and 5B, when the UE determines that there are three sub-bands (e.g., sub-bands 501, 502, and 503) within the carrier 500, each bitmap in the SPI may include three “bits” and each “bit” corresponds to one of the three sub-bands and indicates a transmission direction for the corresponding sub-band. Here, a “bit” represents a grid point in the bitmap.

Each “bit” of a bitmap in the SPI may have the following values:
1. a first value indicating an uplink transmission direction for the corresponding sub-band, which is represented by “U” in FIG. 5B; or
2. a second value indicating a downlink transmission direction for the corresponding sub-band, which is represented by “D” in FIG. 5B; or
3. a third value indicating a flexible transmission direction for the corresponding sub-band, which is represented by “F” in FIG. 5B.

In some embodiments, the “bit” of the bitmap in the SPI may have a fourth value indicating a non-valid state of the “bit”, which is represented by “-” in FIG. 5B.

In some embodiments, the number of bitmaps included in the SPI may be equal to 14×K₁, wherein K₁ is the maximum number of slot formats included in a slot format combination. In such cases, the UE determines a bitmap in the SPI to be valid only when the SFI in the first DCI message indicates that the symbol associated with the bitmap is a flexible symbol. For example, when symbol #0 is indicated by the SFI as a downlink or uplink symbol, the UE may determine the bitmap associated with symbol #0 to be invalid regardless of the values of “bits” in the bitmap.

In some other embodiments, the number of bitmaps included in the SPI may be equal to 14×K₂, wherein K₂ is the monitoring periodicity for the first DCI message. In such cases, the UE determines a bitmap in the SPI to be valid only when the SFI in the first DCI message indicates that the symbol associated with the bitmap is a flexible symbol. For example, when symbol #0 is indicated by the SFI as a downlink or uplink symbol, the UE may determine the bitmap associated with symbol #0 to be invalid regardless of the values of “bits” in the bitmap.

In some other embodiments, the number of bitmaps included in the SPI may be equal to K₃, wherein K₃ is the maximum number of flexible symbols in a slot format combination. In such cases, the SPI may only include bitmaps associated with flexible symbols as indicated by the SFI.

For the slot shown in FIG. 5B, an SFI 510 in a first DCI message 504 may indicate a slot format as “DDDFFFFFFFFUUU.” It is contemplated that the SFI 510 may indicate slot format(s) for other slot(s) not shown. An SPI 520A in the first DCI message 504 may include the following 14 bitmaps associated with symbol #0 to symbol #13 in the slot, respectively:
1. Bitmap 520A00: “ - - - ”;
2. Bitmap 520A01: “ - - - ”;
3. Bitmap 520A02: “ - - - ”;
4. Bitmap 520A03: “FDF”;
5. Bitmap 520A04: “UDF”;
6. Bitmap 520A05: “UDF”;
7. Bitmap 520A06: “UDF”;
8. Bitmap 520A07: “UDF”;
9. Bitmap 520A08: “UDF”;
10. Bitmap 520A09: “UDF”;
11. Bitmap 520A10: “UFF”;
12. Bitmap 520A11: “ - - - ”;
13. Bitmap 520A12: “ - - - ”; and
14. Bitmap 520A13: “ - - - ”.

In this example, the first, second, and third “bits” in each bitmap correspond to sub-bands 503, 502, and 501 shown in FIG. 5A, respectively. It is contemplated that the correspondence relation between the “bits” and the sub-bands is exemplary and not limiting. It is also contemplated that the SPI 520A may include bitmap(s) associated with symbol(s) in other slot(s) not shown.

As shown in FIG. 5A, based on the SFI 510 and the SPI 520A shown in FIG. 5B, the UE may determine three sub-band-specific slot formats 531, 532, and 533 corresponding to the slot and the sub-bands 501, 502, and 503 respectively. In particular, the UE may determine that the transmission direction is uplink for each sub-band of the set of sub-bands for the uplink symbols indicated by the SFI 510. The UE may determine that the transmission direction is downlink for each sub-band of the set of sub-bands for the downlink symbols indicated by the SFI 510. For a symbol indicated as a flexible symbol by the SFI 510, the UE may further determine the transmission direction for each sub-band in the symbol based on the associated bitmap in the SPI 520A. For example, for symbol #0, which is indicated as a downlink symbol by the SFI 510, the UE may determine that the transmission direction is uplink for each sub-band of the three sub-bands. For symbol #3, which is indicated as a flexible symbol by the SFI 510, the UE may determine the transmission direction for each sub-band based on the associated bitmap 520A03 included in the SPI 520A, which is “FDF”.

In this way, for the slot, the UE may determine the slot format for the slot and for sub-band 501 as “DDDFFFFFFFFUUU,” the slot format for the slot and for sub-band 502 as “DDDDDDDDDDFUUU,” and the slot format for the slot and for sub-band 503 as “DDDFUUUUUUUUUU,” as shown in the sub-band-specific slot formats 531, 532, and 533.

FIG. 5C illustrates another exemplary communication format configuration corresponding to a set of slots and a set of sub-bands within a carrier according to some embodiments of the present disclosure.

In the example shown in FIGS. 5A and 5C, for a carrier 500, a UE (e.g., UE 101 in FIG. 1) can be provided with one or more slot formats after receiving an SFI in a first DCI message and a higher layer signaling. The SFI indicates a slot format for each slot of a set of slots. The number of the slots included in the set of slots equals the number of the one or more slot formats. For the slot shown in FIG. 5C, an SFI 511 in a first DCI message 505 may indicate a slot format as “DDDFFFFFFFFUUU.” It is contemplated that the SFI 511 may indicate slot format(s) for other slot(s) not shown.

The UE may be further configured by the higher layer signaling with locations of a set of SPIs in the first DCI message 505. Based on the configured locations of the SPIs, the UE may find the SPIs in the first DCI message. The total number of SPIs in the set may be configured by a parameter carried by the higher layer signaling. For example, the parameter may indicate that the total number of SPIs is two in the example as depicted in FIG. 5C, that is, SPI 520C2 and SPI 520C3. The SPI may be referred to as other names, and the present disclosure has no intention of limiting the same.

Each SPI is associated with a time-frequency domain resource which consists of a set of contiguous RBs in frequency domain and a set of contiguous symbols in time domain and may indicate:
a starting RB (for example, a common resource block (CRB)) and a number of contiguous RBs of the associated time-frequency domain resource;
a starting symbol and a number of consecutive symbols of the associated time-frequency domain resource; and
a transmission direction (i.e., UL or DL).

As shown in FIG. 5A, three sub-bands (e.g., sub-band 501, sub-band 502, and sub-band 503) may be included in the carrier 500. Each sub-band may include a number of consecutive RBs in frequency domain. For example, sub-band 501 may include RB #00 to RB #09, sub-band 502 may include RB #10 to RB #19, and sub-band 503 may include RB #20 to RB #29. It is contemplated that the sub-bands may include different numbers of RBs in other embodiments.

For example, the SPI 520C2 may indicate that:
the starting RB is RB #10, and the number of contiguous RBs is 10;
the starting symbol is symbol #3, and the number of consecutive symbols is 7; and
the transmission direction is downlink.

Based on the SPI 520C2, the UE may determine that the SPI 520C2 is associated with a time-frequency domain resource which consists of sub-band 502 in frequency domain and symbol #3 to symbol #9 in time domain, and the transmission direction for sub-band 502 and symbols from symbol #3 to symbol #9 is downlink, which may override the transmission direction (i.e., flexible) indicated by the SFI 511.

The SPI 520C3 may indicate that
the starting RB is RB #20, and the number of contiguous RBs is 10;
the starting symbol is symbol #4, and the number of consecutive symbols is 7; and
the transmission direction is uplink.

Based on the SPI 520C3, the UE may determine that the SPI 520C3 is associated with a time-frequency domain resource which consists of sub-band 503 in frequency domain and symbol #4 to symbol #10 in time domain, and the transmission direction for sub-band 503 and symbols from symbol #4 to symbol #10 is uplink, which may override the transmission direction (i.e., flexible) indicated by the SFI 511.

As shown in FIG. 5A, based on the SFI 511, SPI 520C2 and SPI 520C3 shown in FIG. 5C, the UE may determine three sub-band-specific slot formats 531, 532, and 533 corresponding to the slot and the sub-bands 501, 502, and 503 respectively. Specifically, based on the SFI 511 and the SPI 520C2, the UE may determine the sub-band-specific slot format 532 corresponding to sub-band 502 and the slot as “DDDDDDDDDDFUUU”. Based on the SFI 511 and the SPI 520C3, the UE may determine the sub-band-specific slot format 533 corresponding to sub-band 503 and the slot as “DDDFUUUUUUUUUU”. The set of SPIs does not include an SPI associated with a time-frequency domain resource in sub-band 501. Accordingly, the sub-band-specific slot format 531 corresponding to sub-band 501 and the slot is determined based on the SFI 511, which is “DDDFFFFFFFFUUU”.

FIG. 5D illustrates another exemplary communication format configuration corresponding to a set of slots and a set of sub-bands within a carrier according to some embodiments of the present disclosure.

As shown in FIG. 5A, a slot may include 14 symbols, e.g., symbol #0 to symbol #13. A UE (e.g., UE 101 in FIG. 1) may determine that there are three sub-bands (e.g., sub-band 501, sub-band 502, and sub-band 503) within a carrier 500. In the example shown in FIG. 5D, for the carrier 500, the UE may receive at least one SFI (e.g., SFI 541, SFI 542, and SFI 543) in one or more DCI messages. Each SFI indicates a slot format for each slot of a set of slots and for an associated sub-band of the three sub-bands within the carrier 500.

In some embodiments, each of the one or more DCI messages may include one SFI and one SPI. The SPI may indicate an index of the sub-band associated with the SFI in the same DCI message. Also, the SPI may be referred to as other names, and the present disclosure has no intention of limiting the same.

For example, for the slot shown in FIG. 5D, the UE may receive a first DCI message which includes a first SFI 543 indicating a first slot format 553 as “DDDFUUUUUUUUUU,” and a first SPI indicating an index of sub-band 503. Then, the UE may determine a slot format for the slot and for sub-band 503 as “DDDFUUUUUUUUUU,” as shown in the sub-band-specific slot format 533 in FIG. 5A.

The UE may receive another first DCI message which includes a second SFI 542 indicating a second slot format 552 as “DDDDDDDDDDFUUU,” and a second SPI indicating an index of sub-band 502. Then, the UE may determine a slot format for the slot and for sub-band 502 as “DDDDDDDDDDFUUU,” as shown in the sub-band-specific slot format 532 in FIG. 5A.

The UE may further receive one more first DCI message which includes a third SFI 541 indicating a third slot format 551 as “DDDFFFFFFFFUUU,” and a third SPI indicating an index of sub-band 501. Then, the UE may determine a slot format for the slot and for sub-band 501 as “DDDFFFFFFFFUUU,” as shown in the sub-band-specific slot format 531 in FIG. 5A.

It is contemplated that the DCI messages respectively including the SFIs 541, 542, and 543 may be received in any order. In the case that the UE does not receive any DCI message indicating a slot format associated with a certain sub-band, the UE may determine a default slot format (e.g., “FFFFFFFFFFFFFF”) for that sub-band.

In some other embodiments, the UE may receive multiple pairs of SFIs and SPIs in a first DCI message. In one pair of SFI and SPI, the SFI indicates a slot format for each slot of a set of slots and for an associated sub-band, and the SPI indicates an index of the associated sub-band.

For example, for the slot shown in FIG. 5D, the UE may receive a DCI message which includes three pairs of SFIs and SPIs. In the first pair of SFI and SPI, the SFI (e.g., SFI 541) may indicate a first slot format 551 as “DDDFFFFFFFFUUU,” and the SPI may indicate an index of sub-band 501; in the second pair of SFI and SPI, the SFI (e.g., SFI 542) may indicate a second slot format 552 as “DDDDDDDDDDFUUU,” and the SPI may indicate an index of sub-band 502; in the third pair of SFI and SPI, the SFI (e.g., SFI 543) may indicate a third slot format 553 as “DDDFUUUUUUUUUU.” and the SPI may indicate an index of sub-band 503. Then, the UE may determine a slot format for the slot and for sub-band 501 as “DDDFFFFFFFFUUU,” a slot format for the slot and for sub-band 502 as “DDDDDDDDDDFUUU.” and a slot format for the slot and for sub-band 503 as “DDDFUUUUUUUUUU,” as shown in the sub-band-specific slot formats 531, 532, and 533 in FIG. 5A. The three pairs may be arranged in the DCI message in any order. Also, in the case that the UE does not receive any DCI message indicating a slot format associated with a certain sub-band, the UE may determine a default slot format (e.g., “FFFFFFFFFFFFFF”) for that sub-band.

In some other embodiments, the UE may receive one or more SFIs and an SPI in a DCI message. Each SFI may indicate a slot format for each slot of a set of slots and for an associated sub-band of a set of sub-bands (e.g., sub-band 501, sub-band 502, and sub-band 503). The SPI may include a bitmap. The bitmap has one-to-one correspondence to the set of sub-bands. Each “bit” in the bitmap corresponds to one sub-band in the set of sub-bands, and indicates whether the DCI message includes an SFI associated with the sub-band. For example, a bit value of “0” may indicate that the DCI message does not include an SFI associated with the sub-band, and a bit value of “1” may indicate that the DCI message includes an SFI associated with the sub-band.

For example, the bitmap may include three bits corresponding to sub-band 501, sub-band 502, and sub-band 503, respectively. When the bitmap is “011,” it may indicate that the DCI message includes SFIs associated with sub-band 502 and sub-band 503 but does not include an SFI associated with sub-band 501. Then, the UE may determine the slot format for sub-band 502 and the slot format for sub-band 503 according to the associated SFIs included in the DCI message. In the example shown in FIG. 5D, the UE may receive a DCI message including SFIs 541, 542, and 543 and an SPI including a bitmap of “111.” The SFI 541 may indicate a first slot format 551 as “DDDFFFFFFFFUUU,” the SFI 542 may indicate a second slot format 552 as “DDDDDDDDDDFUUU,” and the SFI 543 may indicate a third slot format 553 as “DDDFUUUUUUUUUU.” Then, the UE may determine a slot format for the slot and for sub-band 501 as “DDDFFFFFFFFUUU,” a slot format for the slot and for sub-band 502 as “DDDDDDDDDDFUUU,” and a slot format for the slot and for sub-band 503 as “DDDFUUUUUUUUUU,” as shown in the sub-band-specific slot formats 531, 532, and 533 in FIG. 5A.

In some other embodiments, for the three sub-bands shown in FIG. 5A, the UE may receive a DCI message including three SFIs, and each SFI indicates a slot format associated with one sub-band. According to an embodiment, the three SFIs may be consecutive in the DCI message. The UE may be provided with a location of the first SFI in order and then determine the locations of the next two SFIs based on a size of each SFI.

For example, as shown in FIG. 5D, the three SFIs (e.g., SFIs 541, 542, and 543) in the received DCI message are associated with sub-band 501, sub-band 502, and sub-band 503, respectively. The SFI 541 associated with sub-band 501 may indicate a slot format 551 (“DDDFFFFFFFFUUU”) for sub-band 501, the SFI 542 associated with sub-band 502 may indicate a slot format 552 (“DDDDDDDDDDFUUU”) for sub-band 502, and the SFI 543 associated with sub-band 503 may indicate a slot format 553 (“DDDFUUUUUUUUUU”) for sub-band 503. Based on the SFIs associated with each sub-band, the UE may determine the sub-band-specific slot formats 531, 532, and 533 for the slot as shown in FIG. 5A.

In some embodiments, in the case that a UE is indicated to transmit at least one UL transmission (e.g., a physical uplink control channel (PUCCH) transmission) on a set of REs after receiving a higher layer signaling and/or a third DCI message from a BS, and the set of REs corresponds to a number of symbols in time domain and one or more sub-bands in frequency domain, after determining one or more sub-band-specific slot formats (e.g., sub-band-specific slot formats 531, 532, and 533 as shown in FIG. 5A) corresponding to a set of slots and a set of sub-bands according to some embodiments of the present disclosure, the UE may perform the at least one uplink transmission if all the sub-band-specific slot formats corresponding to the one or more sub-bands corresponding to the set of REs indicates that the number of symbols corresponding to the set of REs are uplink symbols.

In some embodiments, in the case that a UE is indicated to receive at least one DL transmission (e.g., a physical downlink reference signal transmission) on a set of REs after receiving a higher layer signaling and/or a third DCI message from a BS, and the set of REs corresponds to a number of symbols in time domain and one or more sub-bands in frequency domain, after determining one or more sub-band-specific slot formats (e.g., sub-band-specific slot formats 531, 532, and 533 as shown in FIG. 5A) corresponding to a set of slots and a set of sub-bands according to some embodiments of the present disclosure, the UE may receive the at least one DL transmission if all the sub-band-specific slot formats corresponding to the one or more sub-bands corresponding to the set of REs indicates that the number of symbols corresponding to the set of REs are downlink symbols.

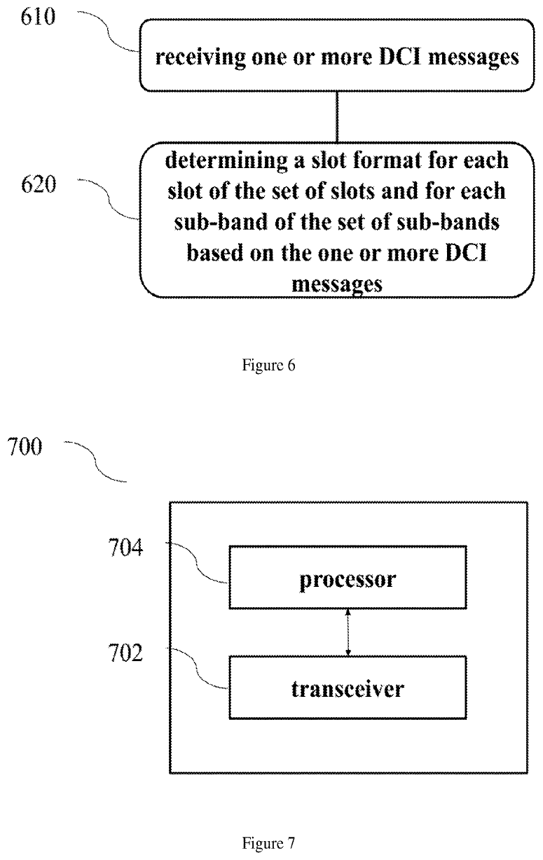

FIG. 6 illustrates a flow chart of an exemplary procedure of wireless communications in accordance with some embodiments of the present disclosure. Details described in all of the foregoing embodiments of the present disclosure are applicable for the embodiments shown in FIG. 6. In some examples, the procedure may be performed by a UE, for example, a UE 101 in FIG. 1.

In operation 610, the UE may receive one or more DCI messages, wherein the one or more DCI messages indicate a communication format configuration corresponding to a set of slots and a set of sub-bands within a carrier. In operation 620, the UE may determine a slot format for each slot of the set of slots and for each sub-band of the set of sub-bands based on the one or more DCI messages. For example, referring to FIG. 5B, the UE may receive a first DCI message 504 including a SFI 510 and a SPI 520A, and the first DCI message 504 (more specifically, the SFI 510 and the SPI 520A) indicates a communication format configuration corresponding to a set of slots and a set of sub-bands within a carrier. The SFI 510 indicates a slot format for each slot of a set of slots and for all sub-bands of the set of sub-bands, and the SPI 520A indicates a sub-band pattern at least for each symbol of a set of symbols which are indicated by the SFI 510 to be flexible symbols. A sub-band pattern indicates a transmission direction (e.g., downlink, uplink or flexible) for each sub-band of the set of sub-bands. The UE may determine a slot format for each slot of the set of slots and for each sub-band of the set of sub-bands based on the first DCI message 504, i.e., based on the SFI 510 and the SPI 520A, that is, a sub-band-specific slot format for each slot of the set of slots and for each sub-band of the set of sub-bands.

In some embodiments, the one or more DCI messages include at least one SFI indicating a slot format for each slot of the set of slots. For example, the SFI 510 as shown in FIG. 5B and the SFI 511 as shown in FIG. 5C indicate a slot format for each slot of the set of slots.

In some embodiments, the one or more DCI messages further include an SPI including a set of bitmaps, wherein each bitmap of the set of bitmaps is associated with a symbol in the set of slots and indicates a transmission direction for each sub-band of the set of sub-bands. In some embodiments, a bitmap of the set of bitmaps is valid in determining the slot format for each slot of the set of slots and for each sub-band of the set of sub-bands when it is associated with a flexible symbol indicated by the slot format indicated by the SFI. For example, for SPI 520A as shown in FIG. 5B, bitmap 520A01 is invalid because it is associated with a DL symbol as indicated by the SFI 510, and bitmap 520A03 is valid because it is associated with a flexible symbol as indicated by the SFI 510.

In some embodiments, a number of bitmaps included in the set of bitmaps is determined based on one of: a maximum number of slot formats included in a slot format combination, a monitoring periodicity for the one or more DCI messages, or a maximum number of flexible symbols in a slot format combination. For example, the number of bitmaps included in the SPI may equal 14×K₁, wherein K₁ is the maximum number of slot formats included in a slot format combination.

In some embodiments, the one or more DCI messages further include a set of SPIs, wherein each SPI in the set of SPIs indicates: a starting RB and a number of contiguous RBs of an associated time-frequency domain resource; a starting symbol and a number of consecutive symbols of the associated time-frequency domain resource; and a transmission direction. For example, the set of SPIs may include SPI 520C2 and SPI 520C3 as shown in FIG. 5C. The total number of the SPIs in the set may be provided by a parameter carried by higher layer signaling. For example, the parameter may indicate that the total number of the SPIs is two as depicted in FIG. 5C.

In some embodiments, the one or more DCI messages include one or more pairs of SFIs and SPIs, each SPI corresponds to an SFI and indicates an index of a sub-band associated with the corresponding SFI, and each SFI indicates a slot format for each slot of the set of slots and for an associated sub-band of the set of sub-bands.

In some embodiments, the one or more DCI messages include one or more SFIs and one SPI, each SFI indicates a slot format for each slot of the set of slots and for an associated sub-band of the set of sub-bands, and the SPI includes a bitmap indicating the sub-band(s) associated with the one or more SFIs.

In some embodiments, the one or more DCI messages include a set of SFIs, and each SFI indicates a slot format for each slot of the set of slots and for an associated sub-band of the set of sub-bands in the set of symbols. For example, the DCI messages may include three SFIs respectively indicate slot formats 551, 552, and 553 as shown in FIG. 5D.

FIG. 7 illustrates a simplified block diagram of an exemplary apparatus 700 according to some embodiments of the present disclosure. As shown in FIG. 7, the apparatus 700 may include at least one processor 704 and at least one transceiver 702 coupled to the processor 704. The apparatus 700 may be or include at least part of a UE or a BS.

Although in this figure, elements such as the transceiver 702 and the processor 704 are described in the singular, the plural is contemplated unless a limitation to the singular is explicitly stated. In some embodiments of the present disclosure, the transceiver 702 may be divided into two devices, such as a receiving circuitry and a transmitting circuitry. In some embodiments of the present disclosure, the apparatus 700 may further include an input device, a memory, and/or other components.

In some embodiments of the present disclosure, the apparatus 700 may be a UE. The transceiver 702 and the processor 704 may interact with each other so as to perform the operations of the UE described with respect to any of FIGS. 1-6. In some embodiments of the present disclosure, the apparatus 700 may be a BS. The transceiver 702 and the processor 704 may interact with each other so as to perform the operations of the BS described with respect to any of FIGS. 1-6.

In some embodiments of the present disclosure, the apparatus 700 may further include at least one non-transitory computer-readable medium.

For example, in some embodiments of the present disclosure, the non-transitory computer-readable medium may have stored thereon computer-executable instructions to cause the processor 704 to implement any method performed by the UE as described above. For example, the computer-executable instructions, when executed, may cause the processor 704 interacting with the transceiver 702 to perform the operations of the UE described with respect to any of FIGS. 1-6.

In some embodiments of the present disclosure, the non-transitory computer-readable medium may have stored thereon computer-executable instructions to cause the processor 704 to implement any method performed by the BS as described above. For example, the computer-executable instructions, when executed, may cause the processor 704 interacting with the transceiver 702 to perform the operations of the BS described with respect to any of FIGS. 1-6.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1. A user equipment (UE), comprising:
at least one memory; and
at least one processor coupled with the at least one memory and configured to cause the UE to:
receive one or more downlink control information (DCI) messages, wherein the one or more DCI messages indicate a communication format configuration corresponding to a set of slots and a set of sub-bands within a carrier; and
determine a slot format for each slot of the set of slots and for each sub-band of the set of sub-bands based on the one or more DCI messages.

2. The UE of claim 1, wherein the one or more DCI messages include at least one slot format indicator (SFI) indicating a slot format for each slot of the set of slots.

3. The UE of claim 2, wherein the one or more DCI messages further include a sub-band pattern indicator (SPI) including a set of bitmaps, wherein each bitmap of the set of bitmaps is associated with a symbol in the set of slots and indicates a transmission direction for each sub-band of the set of sub-bands.

4. The UE of claim 3, wherein a bitmap of the set of bitmaps is valid in determining the slot format for each slot of the set of slots and for each sub-band of the set of sub-bands when it is associated with a flexible symbol indicated by the slot format indicated by the SFI.

5. The UE of claim 3, wherein a number of bitmaps included in the set of bitmaps is determined based on one of: a maximum number of slot formats included in a slot format combination, a monitoring periodicity for the one or more DCI messages, or a maximum number of flexible symbols in a slot format combination.

6. The UE of claim 2, wherein the one or more DCI messages further include a set of sub-band pattern indicators (SPIs), wherein each SPI in the set of SPIs indicates:
a starting resource block (RB) and a number of contiguous RBs of an associated time-frequency domain resource;
a starting symbol and a number of consecutive symbols of the associated time-frequency domain resource; and
a transmission direction.

7. The UE of claim 1, wherein the one or more DCI messages include one or more pairs of slot format indicators (SFIs) and sub-band pattern indicators (SPIs), each SPI corresponds to an SFI and indicates an index of a sub-band associated with the corresponding SFI, and each SFI indicates a slot format for each slot of the set of slots and for an associated sub-band of the set of sub-bands.

8. The UE of claim 1, wherein the one or more DCI messages include one or more slot format indicators (SFIs) and one sub-band pattern indicator (SPI), each SFI indicates a slot format for each slot of the set of slots and for an associated sub-band of the set of sub-bands, and the SPI includes a bitmap indicating one or more sub-bands associated with the one or more SFIs.

9. The UE of claim 1, wherein the one or more DCI messages include a set of slot format indicators (SFIs), and each SFI indicates a slot format for each slot of the set of slots and for an associated sub-band of the set of sub-bands.

10. The UE of claim 1, wherein the at least one processor is further configured to cause the UE to:
receive at least one configuration for an uplink transmission corresponding to one or more sub-bands of the set of sub-bands and a number of symbols in the set of slots; and
perform the uplink transmission based at least in part on the determined slot formats corresponding to the one or more sub-bands indicate that the number of symbols are uplink symbols.

11. The UE of claim 1, wherein the at least one processor is further configured to cause the UE to:
receive at least one configuration for a downlink transmission corresponding to one or more sub-bands of the set of sub-bands and a number of symbols in the set of slots; and
receive the downlink transmission based at least in part on the determined slot formats corresponding to the one or more sub-bands indicate that the number of symbols are downlink symbols.

12. A method performed by a user equipment (UE), comprising:
receiving one or more downlink control information (DCI) messages, wherein the one or more DCI messages indicate a communication format configuration corresponding to a set of slots and a set of sub-bands within a carrier; and
determining a slot format for each slot of the set of slots and for each sub-band of the set of sub-bands based on the one or more DCI messages.

13. The method of claim 12, wherein the one or more DCI messages include at least one slot format indicator (SFI) indicating a slot format for each slot of the set of slots.

14. The method of claim 13, wherein the one or more DCI messages further include a sub-band pattern indicator (SPI) including a set of bitmaps, wherein each bitmap of the set of bitmaps is associated with a symbol in the set of slots and indicates a transmission direction for each sub-band of the set of sub-bands.

15. A base station, comprising:
at least one memory; and
at least one processor coupled with the at least one memory and configured to cause the base station to:
transmit one or more downlink control information (DCI) messages, wherein the one or more DCI messages indicate a communication format configuration corresponding to a set of slots and a set of sub-bands within a carrier.

16. A processor for wireless communication, comprising:
at least one controller coupled with at least one memory and configured to cause the processor to:
receive one or more downlink control information (DCI) messages, wherein the one or more DCI messages indicate a communication format configuration corresponding to a set of slots and a set of sub-bands within a carrier; and
determine a slot format for each slot of the set of slots and for each sub-band of the set of sub-bands based on the one or more DCI messages.

17. The processor of claim 16, wherein the one or more DCI messages include at least one slot format indicator (SFI) indicating a slot format for each slot of the set of slots.

18. The processor of claim 17, wherein the one or more DCI messages further include a sub-band pattern indicator (SPI) including a set of bitmaps, wherein each bitmap of the set of bitmaps is associated with a symbol in the set of slots and indicates a transmission direction for each sub-band of the set of sub-bands.

19. The processor of claim 18, wherein a bitmap of the set of bitmaps is valid in determining the slot format for each slot of the set of slots and for each sub-band of the set of sub-bands when it is associated with a flexible symbol indicated by the slot format indicated by the SFI.

20. The processor of claim 18, wherein a number of bitmaps included in the set of bitmaps is determined based on one of: a maximum number of slot formats included in a slot format combination, a monitoring periodicity for the one or more DCI messages, or a maximum number of flexible symbols in a slot format combination.
